(19) United States
(12) Patent Application Publication
(10) Pub. No.: US 2020/0209274 A1
(43) Pub. Date: Jul. 2, 2020

(54) PIPETTING DEVICE WITH FUNCTIONAL CHECKING AND METHOD FOR FUNCTIONAL CHECKING OF A PIPETTING DEVICE

(71) Applicant: EPPENDORF AG, Hamburg (DE)

(72) Inventors: Uwe DUNKER, Hamburg (DE); Michael SCHICKE, Hamburg (DE); Tobias DAVID, Barkhausenweng (DE)

(21) Appl. No.: 16/634,092

(22) PCT Filed: Jul. 26, 2018
(86) PCT No.: PCT/EP2018/070278

§ 371 Date: Jan. 24, 2020

(30) Foreign Application Priority Data
Jul. 27, 2017 (EP) 17183583.8

(51) Int. Cl. G01N 35/10; G01N 35/00

(52) U.S. Cl. CPC G01N 35/1016; G01N 35/1002; G01N 35/00623

(57) ABSTRACT

The invention relates to methods and to pipetting apparatuses for detecting at least one performance state of the suction mechanism of a pipetting device used for pipetting. Such a method and such a pipetting apparatus each use an electronic control device, a suction mechanism which, amongst other things, has an electrically powered motor, a measurement device have a pressure sensor or a measurement device acquiring the motor current for characterizing the physical work which is performed by the suction mechanism, wherein the pipetting device can partly be provided with a resistance device by means of which, during the execution of the method, the mechanical, in particular the hydraulic, resistance of the suction mechanism against the physical work performed by the motor is increased, wherein the control device is configured to detect a performance state of the pipetting apparatus, to acquire at least one value of this measurement value in function of a defined movement of the piston element, to store the at least one value of this measurement value in the data storage device.

The invention relates to an electric pipetting apparatus with functional checking and a method for the functional checking of an electronic pipetting apparatus.

In the present invention, handheld laboratory devices that are commonly used in medical, biological, biochemical, chemical and other laboratories are denominated pipetting apparatus. In the laboratory, they serve for the precise dosage as well as for the transport of fluid samples in small volumes and for the transfer of such volumes between different sample containers. In pipetting apparatuses, e.g. fluid samples are sucked by a partial vacuum into pipetting containers, e.g. pipette tips, are stored there, and are released again from there at the target position. An electronic pipetting apparatus employs at least one electronic operational parameter that influences at least or controls the operation of the pipetting apparatus. Electronic pipetting apparatuses are denominated in the following also in an abbreviated form with the term “pipetting apparatuses”.

The class of pipetting apparatuses is constituted of e.g. hand-held pipettes and repeater pipettes, with the latter being denominated also as dispenser. A pipette is to be understood as a device, with which a sample that is to be pipetted can be sucked into a pipetting container by means of a moving device that can be attached to the device and that can comprise in particular a piston, with the pipetting container being connected in a detachable manner to the pipette. In the case of an air cushion pipette, the piston is attached to the device, and between the sample to be pipetted and the end of the piston, an air cushion is located that is, for the uptake of the sample into the pipetting container, exposed to a partial vacuum, by which the sample is sucked into the pipetting container and/or retained in the pipetting container. A dispenser is to be understood as a device, with which a volume that is to be pipetted can be sucked into a pipetting container that is connected to the dispenser—in particular a dispenser tip that is formed following the principle of syringe—by means of a moving device that can comprise in particular a piston, with the moving device being allocated at least partially to pipetting container, e.g. by arranging the piston in the pipetting container. In the case of the dispenser the end of the piston is located very near the sample that is to be pipetted or it is in contact with the it, which is why the dispenser is also denominated positive displacement pipette. Pipette tips or dispenser tips consist preferably of plastic and, being disposable items, they can after use be discarded respectively replaced by a new pipette tip or dispenser tip. Pipette tips or dispenser tips are provided in different sizes for dosing in in different volume ranges.

In a pipetting apparatus, the amount of sample that is dispensed by a single actuation can correspond to the amount of sample sucked into the device. It can also be provided that a taken up amount of sample that corresponds to several dispensing volumes is dispensed stepwise. Furthermore, it is to be distinguished between a single channel pipetting apparatuses and multi-channel pipetting apparatuses, with single channel pipetting apparatuses comprising only one single dispensing-/uptake channel and multi-channel pipetting apparatuses comprising several dispensing-/uptake channels that allow for in particular the parallel dispensing or uptake of multiple samples.

Examples of handheld, electronic pipettes are the Eppendorf Xplorer® and Xplorer® plus of the Eppendorf AG, Germany, Hamburg; examples of handheld, electronic dispensers are the Multipette® E3 and Multipette® E3x of the Eppendorf AG, Germany, Hamburg. In the same manner as the pipetting apparatus according to the present invention, these device are operated electrically by moving the pipetting mobile part, in particular the piston, by means of an electrical motor device of the pipetting apparatus.

Electrical pipetting apparatuses offer multiple advantages with respect to non-electronical pipetting apparatuses as a plurality of functions can be implemented easily. In particular, the execution of specific, program-controlled pipetting processes can be simplified with electronic pipetting apparatuses by automatizing these processes fully or partially. Typical operational parameters for the control of such pipetting processes by means of corresponding pipetting programs refer to the volume at the suction of dispensing of fluids, the sequence and repetition of these processes, and if applicable temporal parameters for the temporal distribution of said processes.

Pipetting apparatus serve for the dosing and therefore the measurement of fluid volumes. Being measurement devices the pipetting apparatuses are in many cases subject to a monitoring of the measurement devices. The monitoring requires a calibration of the instruments at regular intervals. The calibration has to be executed under defined physical conditions by qualified staff in compliance with the ISO8655. Typically, this rather time- and cost-intensive process is carried out at intervals of 6 to 12 months. If the pipetting apparatuses are used in compliance with the specifications, such control intervals are generally sufficient. However, typical scenarios of the lab-work comprise situations, in which the user is in doubt about the status of the devices, in particular when multiple users use the same device. Therefore, users desire a simple functional checking of the pipetting apparatus that can be executed at any moment, that determines a performance state of the pipetting apparatus, and that in particular allows for a reliable good/bad-statement.

The documents EP 0 658 769 B1 and WO 96/41200 A1 describe stationary pipetting automats with integrated leak-tightness test, in which an automated leak-tightness test method is applied. It provides the automatic positioning of the pipetting head that is connected to the suction system in order to measure at different positions the pressure (or partial vacuum) applied at the interior of the suction system by means of a pressure sensor integrated into the suction system. In the case of manually handled pipetting apparatuses that are not operating fully automatically this approach is not applicable.

Therefore, a method for testing the leak-tightness of a handheld pipetting apparatus by means of a leak-tightness test device was proposed in the document EP 2 494 328 B1. The method is used in combination with a pipetting apparatus by measuring under defined test conditions the pressure applied at the pipette tip, and comparing it to a reference value. For this purpose, the leak-tightness test device comprises a vacuum pump, pipette tip receptacles, lines, valves, an electronic control device with a data storage and a display device, and a pressure sensor. This solution offers the advantage that only a single leak-tightness test device is needed to test multiple pipetting apparatuses. On the other hand, the functional checking of multiple pipetting apparatuses in the laboratory critically depends on the functionality of the single test device, which must be maintained separately and must be available as a separate measuring device.

Similarly, document EP 0 571 100 A1 describes a hand-held pipetting apparatus with its vacuum cylinder being connected from the outside to a pressure sensor to allow for conclusions on the tightness of the vacuum cylinder when pipetting a desired volume by comparison with a previously obtained reference pressure curve. This approach is also directed to the determination of leak-tightness problems at the pipette.

Also, US 2014/0137980 A1 describes a method for detecting anomalies in pipetting a desired volume by means of a pipetting apparatus that comprises an integrated pressure sensor. Two reference pressure curves are determined in advance and used as a basis for estimating whether the pressure profile detected during pipetting of any volume is within an expected range.

The approaches mentioned for the functional checking in pipetting apparatuses are sometimes complex and limited in the scope of functional checking. The object underlying the present invention is therefore to provide improved methods for the functional checking of a pipetting apparatus and to provide improved pipetting apparatuses with functional checking.

The invention achieves this object in particular by the method according to claim 1, the method according to claim 2, the pipetting apparatus according to claim 12 and the pipetting apparatus according to claim 15. Preferred embodiments are in particular subject matters of the subclaims.
A method according to the present invention in the first preferred embodiment serves to detect at least one performance state of the pipetting suction mechanism of a pipetting apparatus, in particular a pipette or a repeater pipette, with the suction mechanism comprising an electrically driven motor, a piston chamber and a piston element movably mounted therein and driven by the motor, by the movement of which the suction of a fluid forming a fluid flow through an open suction channel of the piston chamber is effected, wherein the pipetting apparatus is configured to detect the motor current drawn by the motor as a measurement value for characterizing the physical work performed by the suction mechanism for the electrically powered movement of said piston element, and
   with the method comprising the following steps, which can be carried out by a data-processing control device of the pipetting apparatus:
a) acquisition of at least one value of this measurement value in function of a defined movement of the piston element;
b) Comparison of the at least one measurement value to at least one reference value.

This step is preferably provided: storing this at least one value of this measured value in a data storage device of the pipetting apparatus. This step is preferably carried out after step a) and in particular before step b). The storage for the purpose of data processing in step b) can, in particular, take place in a volatile data storage, and storage in a non-volatile data storage can take place in particular after step b).

The defined movement of the piston element can in particular also provide a dwell time of the piston in one or more predetermined positions. If the motor current during this dwell time deviates from a reference value, in particular if the motor current changes in the dwell position of the piston, for example reduced to an extent that is outside a predetermined allowable tolerance range, it can be deduced that a leak is present in the suction mechanism respectively the piston chamber.

A further preferred embodiment of the method according to the present invention for determining a performance state, in particular for determining a leakage of the piston chamber, provides the step of moving the piston element to a predetermined position and/or until a predetermined value for the measurement value is observed, of then stopping the piston element and/or switching off the motor, of starting the motor again after a dwell time, which may be between e.g. 5 ms and 5 s, and moving the piston element and/or determining the measurement value. Alternatively or additionally, it is preferred that the motor is operated until the predetermined value of the measurement value or another predetermined value of the measurement value is observed, which can be determined in particular by repeated measurement of the measurement value. This predetermined value of the measurement value may in particular be a maximum permitted motor current (maximum motor current). The maximum motor current may be the value at which a safety device installed in the motor or in an electronic control device, in particular the data-processing control device of the pipetting apparatus, in particular on an electronic circuit board, powers off the motor. The maximum motor current may also be another value set by the manufacturer of the pipetting apparatus. The method may in particular provide that the piston element is moved until the maximum motor current is reached, and that the motor is powered off then; in the case of said safety device, the motor powers off automatically, and in this case in particular the time interval between the restarting and switching off the engine can be determined. After the predetermined dwell time, the engine is restarted. If the motor switches off immediately because of the maximum motor current being reached immediately, it indicates that the piston chamber is leak-tight. On the other hand, if the engine does not immediately switch off again, one can conclude that a leak is present, because in this case air is drawn from the piston chamber again, or alternatively the air in the piston chamber is compressed again until the maximum motor current is reached.

The following statements equally apply to a pipetting apparatus according to the present invention and to a method according to the present invention, unless otherwise stated explicitly. The said optional and preferred procedures can be provided as optional method steps of a method according to the present invention, in particular as such method steps, which can be implemented in a correspondingly arranged pipetting apparatus resp. an electronic control device of the pipetting apparatus. This can be realized in particular by a correspondingly adapted control program code, which can be executed by the electronic control device.

According to a first aspect of the present invention, the current drawn by the electric motor, also referred to as the motor current, is used as a parameter to determine the performance state of a pipetting apparatus. In the experiments on which the invention is based, the motor current was determined as an optimal parameter in order not only to determine fault states of the suction mechanism but also to evaluate the performance state in a more differentiated manner. For this purpose, it is advantageous if the at least one measured value of the measurement value is stored and, in certain embodiments of the invention, also stored permanently and thus remains available for later comparisons.

According to a further aspect of the present invention, it is particularly advantageous to provide the pipetting apparatus with a resistance device, in particular with a separate closure element for the suction channel in order to increase in a predefined manner the mechanical and/or hydraulic resistance, which is applied during the operation of the suction mechanism and which requires a corresponding motor performance that needs to be measured.

The electric motor, in particular a DC motor, uses an electric power Pₑₗ and converts it into a mechanical power P_{mech}. There is a power loss, which under normal circumstances results from the difference between the electrical power of the motor and the mechanical power (working power). Work performance is the power used to perform the mechanical/hydraulic work required under normal circumstances while pipetting a desired volume. A suitable DC motor is offered, for example, by the C.I.Takiron Corporation, Osaka, Japan, in particular as a “DC Coreless motor A12series” type motor, e.g. the model A12B-24-S.

The working power of the motor is typically proportional to the torque M applied to the motor shaft multiplied by the rotational speed n (number of revolutions per unit of time). The power loss of the motor comprises normal friction losses that can be considered as part of the required mechanical work. Furthermore, the power loss comprises heat losses P_{W} due to the electrical resistance R of the motor coils. This heat output can be described as P_{W}=R*I². The power that has to be provided by the motor alone is thus Pₑₗ=P_{mech}+P_{W}. If the motor drives the piston element in the piston chamber during pipetting, in particular via a mechanical transmission, further mechanical friction losses and the hydraulic power during suction/dispensing of the fluid occur. In the case of an air cushion pipette, when the piston is moved in the proximal direction, i.e. away from the pipette tip, the air cushion between the piston element and the fluid sample expands, and it is compressed when the fluid is dispensed (faster than the gravitationally induced release speed). In the case of a positive displacement pipette, the fluid is essentially the liquid sample that is aspirated into a dispensing container or dispensed from it.

The usual temporal development of the motor current Iₘₒₜ(t; P_{arb}) under normal circumstances while performing the working power P_{arb} for pipetting a desired volume V at a predetermined pipetting speed vₚᵢₚ can be assumed to be known, since this information can be determined by reference measurements at the factory or by reference measurements during the operation of the pipetting apparatus and can be stored in a data storage device of the pipetting apparatus. This previously known development I_{ref}=Iₘₒₜ(t; vₚᵢₚ; V) can be stored as a reference development resp. in the form of reference data. The temporal development can consist of several pairs of values (Iₘₒₜ; t) or can consist of a value Iₘₒₜ, which was acquired at a defined moment to during pipetting.

In real operation, the motor current Iₘₒₜ(t; P_{arb}) depends on various further state variables of the pipetting apparatus. Deviations of the temporal development of the motor current at a predefined load while providing a corresponding work can be used as a measure of a power change, in particular a loss of performance of the pipetting apparatus. Certain error conditions of the pipetting apparatus lead to an increased power consumption of the motor. By using previously determined, in particular load-dependent, current values as reference data, a decision can be made by means of a comparative evaluation of the measured data and the reference data as to whether an error condition of the pipetting apparatus is present or not.

Possible error conditions are rooted in particular on leaks or contamination in the suction mechanism, in particular leaks and contamination in the system piston element-piston chamber-suction channel, contamination in the drive system, including the electric motor, its shaft and an optional transmission, possible coarse step errors of the electric motor, and/or heavy wear of one or more components contained in the suction mechanism. Such error conditions can suddenly arise during operation of the pipetting apparatus and can lead to problems during pipetting. It is therefore desirable to have in particular an easily executable, preferably systematic or at least initiated by the user, observation resp. test of the pipetting apparatus with regard to such error conditions.

It is preferably provided to carry out step a) before the execution of a (regular) pipetting process started by the user during operation of the pipetting apparatus. In this case, step a) is carried out in particular during a movement of the piston element that serves exclusively for the detection of at least one performance state. This means that this movement does not serve to perform a—regular—pipetting process and in particular that no laboratory sample is pipetted during the functional checking. Alternatively, it is preferably provided to carry out step a) during a (regular) pipetting process which has been started by the user during operation of the pipetting apparatus and in which, in particular, a laboratory sample is pipetted.

In respectively preferred embodiments of the invention, the functional checking is carried out before, after, or during the regular operation of the pipetting apparatus. To perform the functional checking during a—regular—pipetting process, such a regular pipetting process is considered a predefined load. In a pipetting process, a fluid sample is pipetted with a user-selected volume at a predetermined or user-set pipetting rate. Preferably, those user-selected pipetting processes are used that employ volumes and pipetting rates that are also at the basis of the available reference data. As a result, a precise comparison of the measured motor current—and thus of the executed work—can be carried out with reference values that are valid under these conditions, i.e. ideal values. This is done in particular in step b) of the method.

Preferably, it is provided to carry out step a) during a (regular) pipetting process started by the user during operation of the pipetting apparatus, namely at the beginning of the pipetting process, in particular within milliseconds from the start of the pipetting process, in particular within the number of N milliseconds of the pipetting process, with N being preferably selected from the range 100 to 1000, 100 to 2000 or 100 to 4000. As a result, an error condition can be detected early.

A measurement process, which is provided in step a), can provide, in particular, that during the movement of the piston element, a number of N measured values of the measurement value are detected, that can be determined e.g. in equidistant time intervals, or at equidistant intervals of the motor revolutions or at equidistant intervals of the position of the piston element. The reference data used for comparison equally exhibit preferably N current values. If the number of current values in the measured data record of the measurement value deviates from the number of current values in the reference data, an interpolation or extrapolation can be applied.

During the piston movement, a partial vacuum is generated in the piston chamber, by which a fluid is aspirated. According to the Boyle-Marriotte law, the product of pressure p and volume V is ideally constant (p*V=constant) in the case of air, so that the increase of pressure is ideally indirectly proportional to the expanded volume or the travel of the piston element. The motor current profile measured during this process is essentially proportional to the pressure development in the piston chamber. The same applies to the case of generating an overpressure in the piston chamber for dispensing a fluid sample.

It is also possible to determine the moments during the piston movement, for which predetermined current values are observed. For example, at least one moment—at an interval from a moment of the piston movement in step a)—can be determined, at which at least one predetermined value of the measurement value is applied.

In a preferred refinement, at least first reference data and second reference data are used to determine suitable reference data for a pipetting process. By a data operation, in particular an interpolation or extrapolation, third reference data can be determined from the first and second reference data. If in the pipetting apparatus, for example, first reference data I_{ref1} for a volume V1 to be pipetted at normal speed and second reference data I_{ref2} for a volume V2 to be pipetted at normal speed are available, and if the pipetting volume V3 selected by the user ranges between V1 and V2, i.e. V1<V3<V2, then an interpolation function can be employed to determine the third reference data I_{ref3}, e.g. a linear interpolation, according to which e.g. I_{ref1}=(V3−V1)/(V2−V1)*(I_{ref1}+I_{ref2})

In a further preferred embodiment of the invention, the functional checking is performed outside of the regular operation of the pipetting apparatus. In this preferred embodiment, the functional checking is preferably performed during a dedicated functional checking program, in which no user-initiated regular pipetting process is executed. In this preferred embodiment of the invention, the functional checking is particularly preferably carried out at moment before the execution of a pipetting process of the pipetting apparatus. This moment can be defined in particular by the user by starting the functional checking by the user by activation by means of the user interface device of the pipetting apparatus. However, this moment in particular may also be determined by the control device in some embodiments of the invention. In this preferred embodiment, the functional checking is preferably performed during a dedicated functional checking program, in which no user-initiated regular pipetting process is executed. This functional checking program is carried out in particular before the pipetting process.

Preferably, the pipetting apparatus is configured to execute at least one functional checking program. In the functional checking program, preferably a method according to the present invention is realized. Preferably, the pipetting apparatus comprises a user interface device and is preferably configured so that the user can start at least one functional checking program. The functional checking program can be configured to assist the user in performing the functional checking. For this purpose, it may in particular be provided for instructions to be output to the user via the user interface device of the pipetting apparatus, which may in particular include to attach or to activate a resistance device, in particular a closure element, to the pipetting apparatus.

The functional checking program generates preferably automatically a predefined movement of the piston element. This predefined movement is preferably configured to aspirate (or dispense) at least one predetermined target volume with at least one predetermined pipetting rate. Precisely one target volume can be pipetted with one pipetting rate or several volumes can be pipetted in sections at the same pipetting rate or at several different pipetting rates. “Pipetting the target volume” in this case means in particular that the piston element is moved as far from the starting position, as would lead under normal circumstances to pipetting the desired target volume. If the suction channel is closed with e.g. a closure element, no volume is aspirated, but only a corresponding pressure change in the piston chamber is effected, which is provided by the motor power Uₘₒₜ*Iₘₒₜ. The functional checking program can also be performed on a real liquid reference sample.

Alternatively, the predefined movement is configured preferably to aspirate (or dispense) a predetermined target volume in a predetermined time. Alternatively, this predefined movement is configured preferably to reach at least one predetermined value of the measurement value and to measure and store in this process at least one of the following values: time span from the start of the piston movement until the at least one value is reached; Final volume resp. piston element position when the at least one value is reached; number of motor revolutions until the at least one value is reached.

If the suction channel is equipped with a resistance device that increases the resistance in pipetting the fluid in a predetermined manner, a predetermined physical work is performed in the piston movement and during the functional checking program a predetermined power is requested that manifests itself in a predetermined increase in the pressure in the piston chamber and/or a—in a predetermined way—depending relationship with the motor current. These expected values are in particular experimentally predetermined and known to the pipetting apparatus as reference data. By measuring the at least one value of the measurement value in step a), an efficient functional checking can be carried out, in particular if the pipetting apparatus is equipped with the resistance device.

The resistance device is preferably a separate component that can be attached in particular to the suction channel of the pipetting apparatus in order to be able to counter the fluid flow during pipetting with a predefined resistance, in particular with a virtually infinitely high resistance, if the suction channel is closed completely gas-tight by a closure element.

Preferably, the resistance device is realized as a closure element that counters the fluid flow during pipetting with a virtually infinitely high resistance if the suction channel is closed completely gas-tight by a closure element. In this case, the air contained in the piston chamber and in the suction channel is expanded when the piston element is retracted, or compressed when the piston element is lowered. In this way, suitable load situations of the pipetting apparatus can be generated very efficiently, and a functional checking can be carried out reliably in these situations.

The closure element can be a closure cap that can be plugged onto or attached to a connection section, in particular a nose cone, of the pipetting apparatus, in particular like a regular pipette tip or dispenser syringe. The closure cap may in particular be a pipetting container, e.g. a pipette tip or dispenser syringe with its passage channel, in particular its outlet, being closed. The closure cap may in particular be formed like a pipetting container, e.g. a commercially available pipette tip or dispenser syringe, whose passage channel, in particular the outlet, is closed. The passage channel is formed of a body of the pipetting container that is opened at its both ends. The body exhibits a substantially cylindrical shell shape with conical and/or cylindrical ends, with one end having the engagement opening for the nose cone of the pipette and the other end having the outlet opening. The suction channel of the pipetting apparatus ends in particular in the outer end of the connection section, resp. the nose cone. The closure cap is fitted in the closed position in a gas-tight manner at the connection section resp. the nose cone. This is achieved in particular by an elastomeric sealing ring that can surround the connecting section resp. nose cone at a predetermined height. For air cushion pipettes, the latter is a preferred embodiment for connecting pipette tips gas-tightly with the suction channel.

An embodiment as a simple closure cap is an efficient solution. The closure cap may comprise a polymer or be made of a polymer, in particular by a casting process, e.g. an injection molding process. The closure cap may also be made of a metal or comprise a metal, in particular steel or aluminum.

When attaching the closure element, a pressure increase that is undesired and changes the measurement results may be generated in the piston chamber, if the closure element is progressed further from the moment of establishment of the gas-tight connection with the suction channel resp. the connection section (nose cone). Therefore, embodiments of the closure element are possible and preferred that comprise an opening with a defined opening cross-section, through which the pressure increase in the piston chamber that may possibly have been generated during the attachment can be reverted by balancing with the ambient pressure before starting the functional checking program. Such a closure element with a defined opening can in particular be a conventional pipette tip resp. dispenser syringe. When using a closure element, it is preferred to establish a gas-tight seal of the suction channel before the functional checking program is started. In particular, it is preferred that the suction channel is closed in a gas-tight manner when the closure element is fitted in its end position on the connecting section resp. the nose cone. Alternatively, the closure element may comprise a valve, for example a check valve, or a closable opening, so that in the closed position a pressure balance is possible manually or controlled by the pipetting apparatus. The connection section may comprise a valve, with which the suction channel can be closed in one or both directions, or whose opening cross-section can be varied in a predefined manner. The valve may be manually controllable or may be electrically controllable by the control device.

Preferably, the resistance device, in particular the closure element, is integrated into the pipetting apparatus or connected to the pipetting apparatus. Preferably, the closure element is provided as a movable part of the pipetting apparatus that can be moved manually or by an electrical control in order to establish a closure position, in which the closure element provides the suction channel with a predetermined flow resistance, in particular closes the flow channel. The closure element can be, for example, a component that can be inserted into the suction channel, in particular longitudinally or transversely, in order to close it. The closure element may be e.g. a latch, an aperture or a flap.

The pipetting apparatus comprises preferably a connection section, in which the suction channel ends. The connection section is preferably the nose cone of pipetting apparatus. Preferably, the connection section comprises a movable closure element, which can be moved between a first position and a second position, in particular by translation and/or rotation. The closure element and the connection section are preferably designed such that the suction channel is opened in the first position, in particular completely, and is closed in the second position, in particular completely, in particular closed gas-tightly. The movable closure element can be a component of the nose cone, in particular the tip of the nose cone, which may have the external shape of a truncated cone. The closure member can be connected to the nose cone such that it can be rotated about the virtual axis of the preferably linear movement of the piston element between the first and second position.

A movable closure element can be configured to be adjustable manually. Additionally or alternatively, a movable closure element can be configured to be adjustable in an apparatus-supported manner, in particular by a transmission device and/or controlled by the control device of the pipetting apparatus. Preferably, the pipetting apparatus comprises an actuator device, with which the movable closure element is adjustable in an apparatus-supported manner. When the movable closure element is arranged at the connecting section or the nose cone, a manually driven actuator element, e.g. a push button, or a mechanically driven actuator element of the actuator device, e.g. a motor-driven component, can be arranged on the pipetting apparatus at a distance from the connection section, in particular in or on a housing section of the pipetting apparatus spaced apart along the longitudinal axis. In this case, the actuator device can comprise a spacer element, by means of which the actuation of the actuator element is transmitted over said distance to the movable closure element.

The actuator device resp. the actuator element and/or the spacer element for actuating a movable closure element can be component(s) of an ejection device for ejecting pipette tips. Such ejection devices comprise a component that can be deflected along a longitudinal axis of the pipetting apparatus, in particular an ejection sleeve, which can be used in particular as a spacer element when it is configured for coupling the ejection movement with the movement of the movable closure element. Thus, the closure position of the closure element can be adjusted by a further component of the pipetting apparatus, in particular by adjusting the position of the closure element by an ejection device for ejecting pipette tips. This can also be electrically controlled by the control device, so that the adjustment of the closure position of the closure element can also be done automatically, i.e. without a user intervention. Preferably, the pipetting apparatus is configured to automatically execute the functional checking program after starting by the user or by the control device.

It is also possible and preferred that the user must perform manually at least one procedure on the pipetting apparatus, so that the functional checking program can run completely. Preferably, this procedure includes that the user equips the pipetting apparatus with the resistance device, by means of which the fluid flow in the suction channel during pipetting (aspiration or dispensing) is opposed by a resistance. In particular, this resistance device can be a closure element that is plugged by the user onto the nose cone, in which the suction channel ends, in order to increase the resistance to the fluid flow in a predetermined manner or to completely seal the suction channel.

The functional checking program is preferably configured to output information for the user in dependence of the progress of the functional checking program by means of an optical and/or acoustic output device (display, LEDs, loudspeaker). In this way, in particular a software wizard can be realized that guides the user through the functional checking program and asks for the execution of any procedures, if necessary.

In a real operation, the motor current Iₘₒₜ(t; P_{arb}) depends on various state variables of the pipetting apparatus. Such states, inasfar as they can be calculated or estimated, are considered in preferred embodiments of the present invention as part of the available reference data, i.e. reference values and/or reference curves.

For example, an energy conversion efficiency can be defined in particular as a ratio of emitted mechanical power to absorbed electric power of the motor.
The invention further relates to, in a further preferred embodiment, a method for detecting at least one performance state of the pipetting suction mechanism of a pipetting apparatus, in particular a pipette or a repeater pipette, with the suction mechanism comprising an electrically powered motor, a piston chamber and a piston element arranged movably in the piston chamber and driven by the motor, and whose movement can effectuate the aspiration of a fluid by the formation of a fluid flow through the open suction channel of the piston chamber, wherein the pipetting apparatus comprises a resistance device, by means of which—during the execution of the method—the mechanical, in particular the hydraulic resistance of the suction mechanism against the physical work performed by the motor is increased, and wherein the pipetting apparatus comprises a pressure sensor measuring the pressure in the piston chamber and is configure to acquire the pressure measure by the pressure sensor as a measurement value for the characterization of the physical work performed by the electrically driven movement of this piston element by means of the suction mechanism, and
wherein the method comprises the following steps, which can be carried out by a data-processing control device of the pipetting apparatus:
a) acquisition of at least one value of this measurement value in function of a defined movement of the piston element;
b) comparison of the at least one measurement value with at least one reference value.
c) optionally: storage of this at least one value of this measurement value in a data storage device of the pipetting apparatus.

By means of the resistance device, in particular a closure element, the suction channel of the pipetting apparatus is blocked in a predetermined manner resp. completely closed. The enclosed dead volume of the pipetting apparatus in the upper position of the piston element is preferably known. By moving the piston element, the air contained in the piston chamber is compressed resp. expanded, resulting in a pressure change inside the sealed piston element-piston chamber space. In particular, p*V=const. applies (Boyle-Marriotte law for an ideal gas). Therefore, the pressure change for the air must be approximately indirectly proportional to the displaced volume resp. the displacement of the piston element.

A measurement of the pressure increase (resp. the pressure drop in the case of the opposite displacement of the piston element) compared to dependency, which has been calculated theoretically or determined by experiment course, allows for conclusions on the functionality resp. the performance and/or the error states of the pipetting apparatus.

The measurement of a pressure difference can be carried out by means of an additional pressure sensor installed in the pipetting apparatus. The second pressure sensor can measure the external pressure.
Preferably, the pipetting apparatus is configured for a wireless or wired data exchange with an external data processing device in order to exchange values of the measurement value with the external data processing device. By this, on the one hand a pipetting apparatus, in particular a plurality of pipetting apparatuses, can be monitored centrally, in order to, for example, trigger a maintenance procedure. On the other hand, value data can be processed centrally, in particular statistically, in particular by averaging, by the acquisition of a plurality of value data, in particular from a plurality of pipetting apparatuses, in order to obtain improved information.

The measurement device for measuring the measurement value is preferably integrated into the electric motor device. An electric motor device is preferably configured to detect and make available an operational parameter of the motor device so that this operational parameter can be read in particular by the electrical control device. The operational parameter is preferably the motor current of the motor device. The motor device can comprise a component of the electrical control device of the pipetting apparatus. In particular, the control device of the motor device can comprise this measurement device. In particular, the motor device can operate in a program-controlled way, can be configured to be software-controlled and/or can comprise a closed-loop controller device integrated in the control device of the motor device. The electrical control device is in particular configured to control the motor device, and/or is in particular configured to control the motor device in a regulated manner by means of a closed-loop controller device of the control device, wherein the at least one measured value can be a measurement value of this closed-loop control, and the at least one speed value can be a control variable of this closed-loop control. The control device is preferably designed as a proportional differential controller (PD controller).

An electric motor device of the pipetting apparatus can comprise an electrically powered stepping motor, in particular the electric motor can be a stepping motor. It is also possible that the motor device comprises a linear motor. Preferably, the electric motor device comprises a DC motor that is preferably powered by a constant DC voltage, with the voltage being especially in the range from 4V to 40V, especially being 5V. The DC motor is preferably driven stepwise. This can be done by the resp. an electrical control device addressing it with a square wave signal whose duty cycle defines in particular the step duration. The square wave signal can in particular run between 0V and 15V. A step can be defined by a period of the periodic square wave signal.

The DC motor is preferably controlled by means of pulse width modulation (PWM). The duty cycle of the control signal controls the rotational speed and thus the speed. The control device is preferably configured to control the DC motor by means of a control signal, which is pulsed, in particular to define the rotational speed by pulse width modulation, in particular by setting the duty cycle.

Preferably, the pipetting apparatus comprises a rotational speed sensor and/or a rotation angle sensor, by means of which the pipette device is configured to detect the number of revolutions resp. the rotation angle of a rotor device of the electric motor or of an element driven by the rotor device, e.g. a transmission element. Preferably, the pipetting apparatus, in particular its control device, is configured to adjust the piston stroke via the number of revolutions measured by means of the rotational speed sensor and via the rotation angle of the rotor device or an element driven by the rotor device, e.g. a transmission element. The suction mechanism is designed in particular so that the self-locking of the electric motor and/or the transmission device coupled to it is used to stop the rotor device of the electric motor.

It is possible that the pipetting apparatus comprises a transmission device, which is arranged in particular between the motor device and the piston element, in order to transmit the movement generated by the motor device to the piston element, in particular to transmit or reduce a rotational speed. The electric motor device can comprise a rotor. The rotor can rotate a spindle of the transmission device, which in turn can cause the (translational) movement of a piston element of the pipetting apparatus.

The suction mechanism comprises an electrically powered motor, a piston chamber and a piston element arranged movably therein and driven by the motor, by the movement of which the suction of a fluid can be effected by forming a fluid flow through an open suction channel of the piston chamber. Similarly, in the case of sample delivery under pressure, it is also provided to create a pressure in the piston chamber by means of the suction mechanism and to direct the fluid flow in the suction channel towards the outside, e.g. to eject the sample from a pipette tip.

The electrical control device, which is designed for data processing, can comprise electrical circuits, in particular integrated circuits, and/or can comprise a microprocessor and/or a CPU, data memory and/or program memory. The control device can be configured for processing resp. executing a program code. The program code can be designed to determine the at least one measured value of the measurement value in step a) and can be designed in particular to implement the preferred embodiments of this function of the pipetting apparatus, which are described in the framework of the invention.

The electrical control device is in particular designed to control a pipetting process according to at least one, in particular according to a plurality of operational parameters, in particular automatically or semi-automatically. Controlling automatically means that, for performing the pipetting process, essentially only a start signal is input by the user via a user interface device of the pipetting apparatus, and/or that in particular the uptake process of at least one fluid sample into at least one transport container connected to the pipetting apparatus can take place resp. takes place without requiring a user input and/or that in particular the dispensing process of at least one fluid sample from at least one transport container connected to the pipetting apparatus can take place resp. takes place without requiring a user input. In a semi-automatic control, besides the input of a start signal, at least one additional user input is required for the execution of the intake resp. dispensing process, e.g. an input with which the user confirms at least one operational parameter to be used after entering the start signal and before the pipetting process is executed. Both the automatic and the semi-automatic control of the pipetting process provide to have the movement of the movable part during the pipetting process being driven by the motor device.

The electrical pipetting apparatus can be configured to be operated in one or more operational modes. An operational mode may provide that a set of one or more operational parameters of the pipetting apparatus that influence or control a pipetting process of the pipetting apparatus is automatically queried, adjusted, and/or applied. The decision on how to set the value of an operational parameter is usually made by the user when using the pipetting apparatus and the operational parameter is set accordingly. At least one operational parameter of the set of operational parameters, in particular this at least one speed value of a speed parameter, is queried by the electrical control device and in particular set by the user via an input by means of the user interface device. An operational mode can provide that the at least one functional checking program for determining a performance state of the pipetting apparatus is executed. A functional checking program can thus be defined by a set of operational parameters that can be stored in the data storage device.

An operational mode can, for example, relate to the “dispensing” (DIS) of a sample, which can be defined via the operational parameters “volume of the single sample”, “number of dispensing step”, “speed of the intake of the sample(s)”, “speed of the dispensing of the sample(s)”. An operational mode can also be the “automatic dispensing” (ADS) of a sample, the “pipetting”. (Pip) of a sample, the “pipetting with subsequent mixing” (P/Mix) of a sample, the “multiple intake” of a sample, also referred to as “reverse dispensing” or as “ASP” for Aspirating, the “Diluting” (Dil) of a sample, also referred to as “dilution”, the “sequential dispensing” (SeqD) of samples, the “sequential pipetting” (SeqP) of samples, or the “reverse pipetting” (rPip) of samples.

A pipetting process of a programmable pipetting apparatus can, in particular during step a) resp. during a functional checking program, typically provide for a certain amount of sample to be taken from a starting container into a pipetting container connected to the pipetting apparatus according to a pipetting program and in particular to be subsequently dispensed into a target container, in to be dispensed in a dosed way. Depending on the application resp. the functional checking, the intake and/or dispensing of the sample (s) can follow certain order patterns, in particular sequences, of intake and dispensing steps, can be time-dependent and can be temporally synchronized. A pipetting process can preferably be controlled by a set of operational parameters, with which the said processes can be influenced in the desired manner.

Operational parameters for controlling a pipetting process preferably relate to the adjustment of the volume to be pipetted, during the step of aspirating the sample into a pipetting container connected to the pipetting apparatus, or the step of dispensing the sample from that pipetting container, if necessary to the sequence and repetition of these steps, and if necessary to temporal parameters in the temporal distribution of these processes, in particular also to a temporal alteration of such processes, in particular to the speed based on this speed value and/or acceleration of the aspiration or dispensing of the sample. According to the present invention, it is provided that during step a) of the method according to the present invention at least one operational parameter, in particular a speed value of a speed parameter, is used by the control device. The at least one value of the operational parameter can be stored in a data storage device that can be accessed by the control device for the execution of the method according to the present invention.

The pipetting process, in particular during step a) or during a functional checking program, is preferably uniquely defined by the set of operational parameters. This set of operational parameters is preferably selected and/or input at least partially and preferably completely by the user, in particular via the operational control device of the pipetting apparatus. Preferably, a control program for the execution of the desired pipetting process is controlled by a set of operational parameters. Each control program can be provided in the form of electrical circuits of the control device, and/or be provided by an executable program code that is suitable for controlling the control device, which is preferably program code controllable and preferably programmable.

The pipetting apparatus is preferably designed to automatically check the parameter values entered by the user, in particular the operational parameters entered for defining a functional checking, and to compare them to an allowed range of the respective operational parameter. If the parameter value entered by the user is outside the allowed range, the input is preferably either not accepted or set to a default value, which can be e.g. the minimum value or the maximum value or the last allowed value entered.

An operational state of the pipetting apparatus denotes an armed state of the pipetting apparatus, in which the operational parameters required for executing a pipetting process have a value, so that the pipetting process can be executed on the basis of these values. An operational state can be a standby state with be minimized energy consumption of the pipetting apparatus. This is preferably designed so that an automatically executable functional checking program is performed when the system is in a standby mode, in particular at predetermined time intervals and/or at predetermined times, e.g. at night. For this purpose, the pipetting apparatus can in particular comprise a real-time clock. It is also possible, by means of an acceleration sensor of the pipetting apparatus, to automatically detect a phase of non-use of the pipetting apparatus by a user in which a functional checking program is then automatically carried out.

Preferably, the electrical control device is configured to automatically evaluate the at least one measured value of the measurement value, in particular to compare it with reference data (step b). It is possible that the function of executing a functional checking program can be activated or deactivated by the user by means of the pipetting apparatus offering corresponding input and/or selection options. Thus, this function is activated in particular in at least one operational state of the pipetting apparatus, while there can also be an operational state in that this function is deactivated, even though it is present in the pipetting apparatus.

Alternatively or in addition to the measurement device, in particular the rotational speed of the electromotive drive and/or the speed of movement of the movable part, in particular the piston of a pipette or the syringe plunger of a dispenser syringe, are measured by means of a sensor of the pipetting apparatus. For this purpose, several sensors can be provided accordingly.

A performance state is a state of the pipetting apparatus, in particular the suction mechanism. It characterizes the performance of the pipetting apparatus by comparing the measurement value with at least one reference value resp. reference data. A performance state characterized as “normal” corresponds to a reference performance state in which the pipetting apparatus is enabled to render the power values provided by the manufacturer. The assessment of whether the performance state corresponds to the reference performance state—resp. whether the pipetting apparatus fulfills the manufacturer's standard according to the measured measurement value—in made taking into account a tolerance range, in which the deviation from the reference performance state is still considered normal. This tolerance range is in particular a tolerance range of the measurement value, that is a specific range accepted as normal of the current consumption resp. of the piston chamber pressure. The performance state can also differ from the reference performance state. In this case, the performance state, in particular the measurement value, lies outside the range of values regarded as normal.

Preferably, the pipetting apparatus comprises a user interface device. This can comprise a touch-sensitive display, referred to as touchscreen, and/or a display, and/or at least one control control switch, -rocker, -lever, and/or -rotary knob. Furthermore, the user interface device can comprise a loudspeaker, in particular in order to output an acoustic signal in dependence on the measured at least one measured value, by means of which the user is informed resp. warned in particular about the measured value and/or a deviation of the at least one value of the measurement value from at least one reference value and/or the automated termination of the pipetting process.

Preferably, the pipetting apparatus comprises a user interface device, a timer and a data storage device for storing digital data, wherein the control device preferably comprises a computing device, in particular a CPU resp. a microprocessor, and is designed to execute a method according to the present invention resp. a functional checking program.

The data storage device is preferably a memory subsegment in a larger memory segment that can be addressed by the control device, and that is in particular defined by software. The memory subsegment can be a file. The memory segment can be a data storage. A memory segment can be a software-managed non-physical storage area physically arranged in a hardware storage. The data storage device can comprise a hardware storage. The data storage device resp. the hardware storage is preferably a permanent, that is non-volatile, data storage, preferably a FLASH memory. The hardware storage is preferably configured to be able to carry out preferably at least 100000, preferably at least 150000, or preferably at least 300000 write cycles or erase cycles. The hardware storage can also be a volatile data memory, e.g. a DRAM or SRAM memory.

Preferably, the pipetting apparatus is designed as a dosing device of a system for titrating liquids, as described in particular in one of the claims 1 to 30 of the european patent application no. 06027038.6, published as EP 1 825 915 A2 of the applicant, resp. described in a preferred embodiment of the system as described in this patent application, with the relevant disclosure of it being incorporated by reference in the present application. Such a pipetting apparatus comprises in particular a reading device for reading the label of the pipetting containers, in particular a syringe or a tip, which are held by a further holding device of the pipetting apparatus and are detachably connected. Such a pipetting container, in particular the syringe or tip, comprises at least one label which comprises, for example, information about the respective type and/or the condition of the pipetting container. The information relates, for example, to the nominal volume and/or the construction type (e.g. shape and/or dimensions) and/or the material and/or the purity and/or the manufacturer and/or the date of manufacture and/or uses of the pipetting container. The dosing device comprises a reading device which is configured to read the label of the syringe or tip, if it is held by means of the further holding device on the dosing device. The control device controls the movement of the movable component, in particular of the piston, in function of the label read by the reading device.

The pipetting apparatus according to the present invention can be a single-channel or a multi-channel pipette. In particular, it can also be a pipette or a repeater pipette (dispenser). The pipetting apparatus is configured for hand-held operation, therefore it is preferably operated single-handedly by a user.

Furthermore, the invention relates to a pipetting apparatus, in particular a pipette or a repeater pipette, for pipetting fluid samples in a laboratory, comprising
a suction mechanism comprising an electrically powered motor, a piston chamber and a piston element arranged movably therein and driven by the motor, by the movement of which the suction of a fluid is effectuated by the formation a fluid flow through an open suction channel of the piston chamber;
a data processing control device comprising at least one data storage device,
a measurement device for detecting the motor current drawn by the motor as a measurement value for characterizing the physical work that is performed by the suction mechanism for the electrically powered movement of this piston element, and
wherein the control device is configured to detect a performance state of the pipetting apparatus,
a) to acquire at least one value of this measurement value in function of a defined movement of the piston element,
b) to store the at least one value of this measurement value in the data storage device.
c) optionally: to compare the at least one value of the measurement value with at least one reference value.

Furthermore, the invention relates to a pipetting apparatus, in particular a pipette or a repeater pipette for pipetting fluid samples in a laboratory, comprising
a suction mechanism comprising an electrically powered motor, a piston chamber and a piston element arranged movably therein and driven by the motor, by the movement of which the suction of a fluid is effectuated by the formation a fluid flow through an open suction channel of the piston chamber;
a data processing control device comprising at least one data storage device,
a measurement device comprising a pressure sensor for the acquisition of the pressure applied in the piston chamber as a measurement value for characterizing the physical work that is performed by the suction mechanism for the electrically powered movement of this piston element,
wherein the pipetting apparatus is equipped with a resistance device, by means of which during the execution of the method the mechanical, in particular the hydraulic resistance of the suction mechanism against the physical work performed by the motor is increased,
wherein the control device is configured to detect a performance state of the pipetting apparatus,
a) to acquire at least one value of this measurement value in function of a defined movement of the piston element,
b) to compare the at least one value of the measurement value with at least one reference value.
c) optionally: to store the at least one value of this measurement value in the data storage device.

Features and preferred embodiments of the pipetting apparatus according to the present invention can be learned from the description of the method according to the present invention and its preferred embodiments.

The invention relates furthermore to a program code that can be executed by a software-controllable pipetting apparatus, in particular pipette or repeater pipette, and with which a method according to the present invention can be implemented in such a pipetting apparatus.

This software controllable pipetting apparatus is enabled to execute the method according to the present invention and, if applicable, one of its preferred embodiments by using the program code, in particular by loading the program code into a program code memory of this software-controlled pipetting apparatus. Therefore, the invention also relates to a program code for a software controllable pipetting apparatus, which is converted or upgraded to a pipetting apparatus according to the present invention by using the program code according to the present invention. In this way, electronic pipetting apparatuses can be retrofitted in order to comprise the properties according to the present invention. In particular, the invention relates to a data storage medium, e.g. an optical data storage medium, e.g. a CD, a flash memory or a hard disk containing this program code according to the present invention.

Further preferred embodiments of the pipetting apparatus according to the present invention and the method according to the present invention will become apparent from the following description of the embodiments in conjunction with the figures and their description. Equal components of the embodiments will be denoted essentially by equal reference numerals, unless otherwise described or otherwise indicated by the context. Individual features of this description can be used to define a preferred embodiment of the present invention.

In the figures:

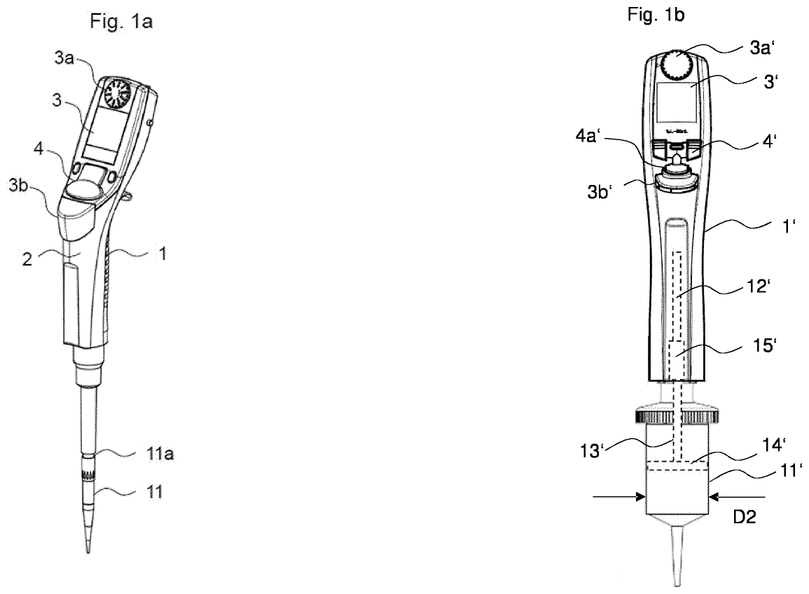

FIG. 1a depicts a perspective lateral view of the pipetting apparatus according to the present invention that is provided as an air-cushion pipette, with its nose cone being connected to a pipette tip.

FIG. 1b depicts a lateral view of a pipetting apparatus according to the present invention that is provided as a repeater pipette in a preferred embodiment, with a dispenser syringe being attached to it.

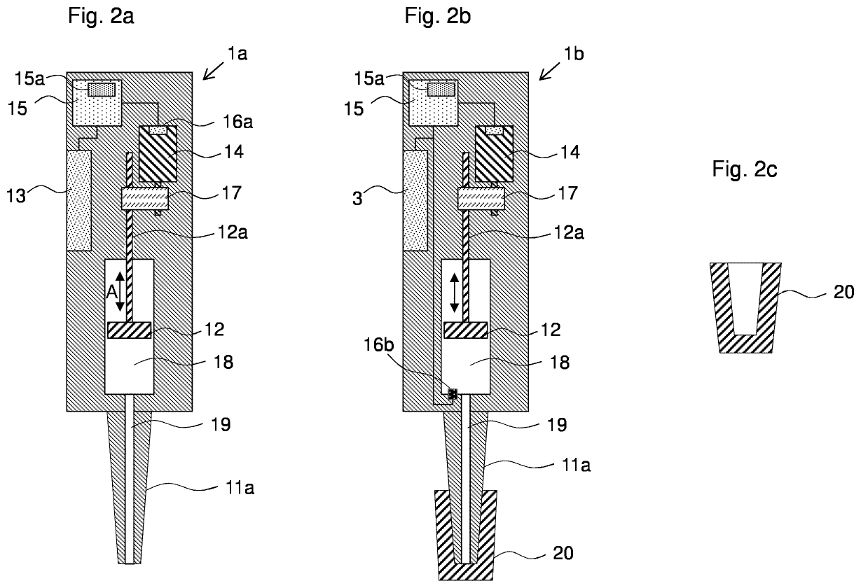

FIG. 2a depicts a first preferred embodiment of the pipetting apparatus according to the present invention, in which the motor current is used as a measurement value to evaluate the performance state of the suction mechanism.

FIG. 2b depicts a second preferred embodiment of the pipetting apparatus according to the present invention with a closure element, in which the pressure in the piston chamber is used for evaluating the performance state of the suction mechanism.

FIG. 2c depicts a closure element that can be used in a functional checking.

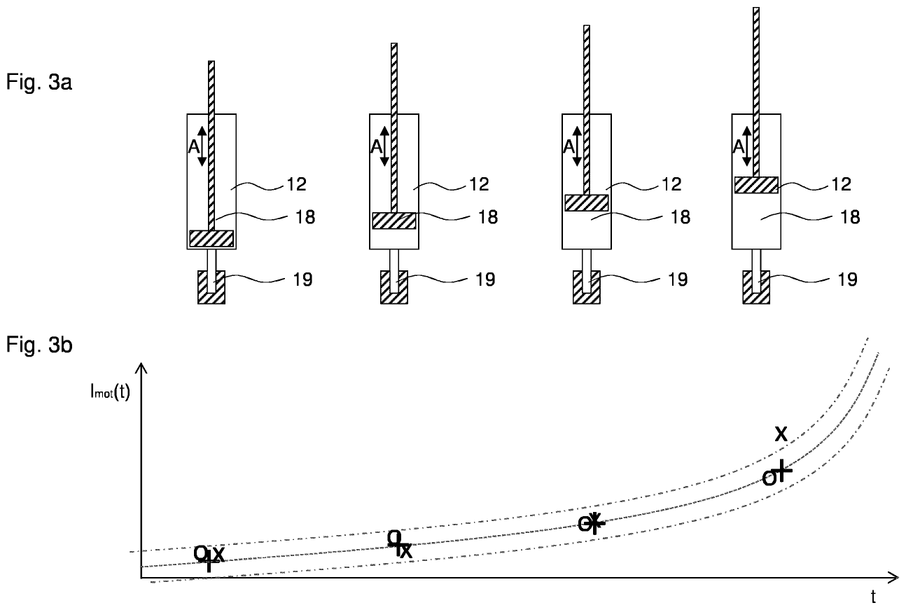

FIG. 3a depicts a series of positions of the piston element that can be used in a measurement of a reference curve of measurement values and in a functional checking according to the method according to the present invention.

FIG. 3b depicts a curve of reference values “+” with a tolerance range and measurement values “o” and “x” of two possible functional checkings carried out according to the method according to the present invention on the pipetting apparatuses from FIG. 1a, 1 b, 2a, 2b.

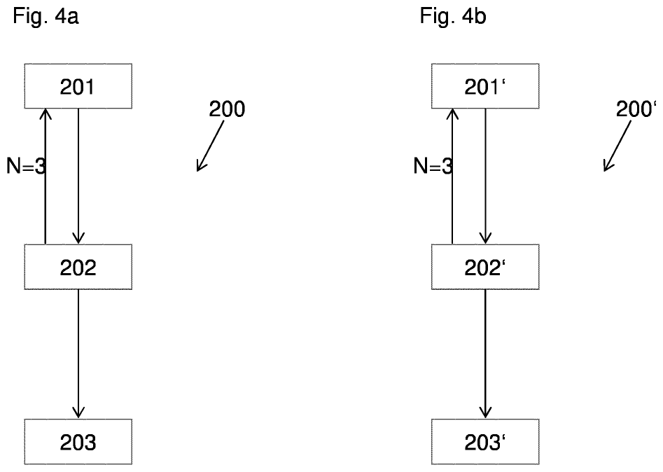

FIG. 4 depicts schematically the process of the method according to the present invention according to an embodiment.

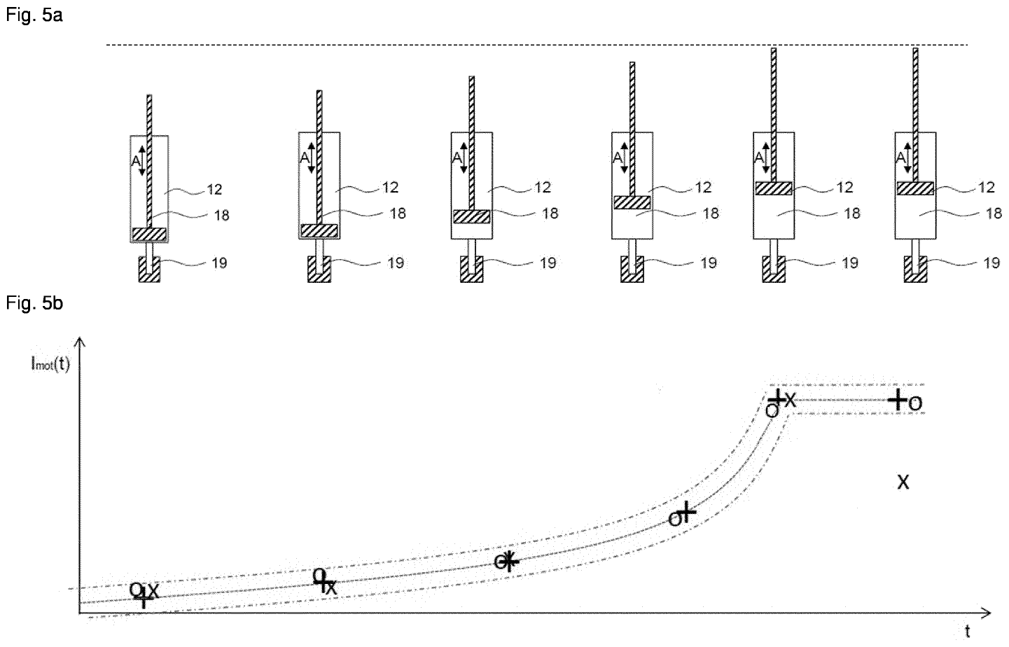

FIG. 5a depicts a series of positions of the piston element that can be used in a measurement of a reference curve of measurement values and in a different functional checking according to the method according to the present invention.

FIG. 5b depicts a curve of reference values “+” with a tolerance range and measurement values “o” and “x” of two possible functional checkings carried out according to the method according to the present invention on the pipetting apparatuses from FIG. 1a, 1 b, 2a, 2b.

FIG. 1a depicts a perspective lateral view of a pipetting apparatus 1 according to the present invention, which is provided as an electronic air cushion pipette 1 and with a pipette tip 11 being connected to the nose cone 11a. The air cushion pipette comprises an integrated piston (not visible, inside the housing 2) that can create a vacuum inside the pipette tip when the piston element in the piston chamber is moved upwards by the electric motor. By this, the sample to be pipetted is sucked into the pipette tip, and the sample is dispensed from the pipette tip by an overpressure in the piston chamber. The typical maximum capacity of such air cushion pipettes are 100 nanoliter to 10 milliliter. The air cushion pipette 1 comprises a user interface device, in particular a dial 3a, a display 3, a control rocker switch 4. With the dial 3a, the operational modes of the pipetting apparatus can be selected. One of these operational modes “functional checking” is used to carry out the method according to the present invention resp. for the selection of a display page for selecting at least one method for functional checking, defined by, if applicable, one or more operational parameters. With the ejection button 3b, the pipette tip can be ejected. The air cushion pipette 1 comprises furthermore an electrical control device and a measurement device for measuring the measurement value (each not visible). FIG. 1b depicts a pipetting apparatus 1′ according to the present invention designed as a repeater pipette 1′ according to a preferred embodiment, to which a dispensing syringe 11′ is connected. The pipetting apparatus comprises a user interface device that comprises a display 3′, which serves in particular to display the values of operational parameters of the pipetting apparatus and serves in particular to describe the operational parameters. By means of a dial 3a′, the operational mode of the dispenser is selected. In an operational mode, a preferred automated dispensing process is defined by means of a set of operational parameters or can be defined by the user by setting or selecting the values of these operational parameters. The user interface device comprises furthermore a control rocker switch 4′ as a control element that comprises an upper and a lower pivoting range. With this control rocker switch, the user navigates through selection menus of the graphical user interface, by means of which the control device queries at least one operational parameter. In the dispensing mode of the pipetting apparatus, the uptake of a fluid volume occurs by suction from an initial container (not shown) into the reservoir of the dispenser syringe by a first actuation of the trigger button 4a′, all subsequent actuations of the trigger button 4a′ each trigger a dispensing step. The operational parameters used for aspirating or dispensing the sample relate in particular to the sample volume to be aspirated and the uptake rate to be used (volume per time) or—equivalently in the case of a known container geometry—the time span to be used for the aspiration. These operational parameters used in the definition of pipetting processes can also be used in a similar way in the definition of a functional checking. The container geometry resp. the container type can be read out automatically in particular via a code in the transport container by the pipetting apparatus by means of a preferably provided reading device. When moving the sample by means of the dispenser syringe 11′, the positive displacement principle is used, as described above.

The piston 13′ with the piston element 14′ of the dispenser syringe 11′ comprises an outwardly exposed connection attachment 15′ that can be connected to a spindle 12′ of the pipetting apparatus—and can be detached from it again. The trigger button 4a′ starts in particular a dispensing process, in which the fluid sample contained in the transport container 11′ is dispensed according to predetermined operational parameters. These operational parameters determine in particular the number of dispensing steps, the dispensing volume of a dispensing step, and the dispensing rate (volume per time), resp. a value proportional thereto, to be met during one dispensing step or multiple or every dispensing steps. The pipetting apparatus 1′ is in particular program-controlled, i.e. the various sets of operational parameters that are each assigned to a pipetting program and therefore to a specific operational mode, can be defined in a program-controlled manner, so that a user selects, if applicable, the desired pipetting program for the execution of the desired pipetting process, and, if desired, sets at least one operational parameter.

The dispenser syringe 11′ comprises a reservoir with a larger diameter d2 and comprises an opening with a smaller diameter d1, d1<d2. The small opening d1 accounts for most of the flow resistance generated by the dispensing syringe 11′ during pipetting. The smaller diameter therefore defines a predetermined resistance that, when pipetting a certain volume at a certain pipetting speed, requires a motor power that corresponds to the reference data in the normal case resp. a behavior according to a reference curve of the measurement value, in particular the motor current. The pipetting apparatus measures the values for the measurement value in step a), compares them in step b) with the reference data and, optionally, stores them in a step c) in a non-volatile data memory. In the case of a deviation, which is generally characterized by leaving a tolerance range in the development of the measurement value or at least one tolerance value for the at least one measurement value, the user is informed and/or the result is stored in the data storage device.

As depicted in FIG. 2a, the pipetting apparatus 1 comprises in a first preferred embodiment among others the following components: a user interface 13 in conjunction with the electrical data processing control device 15, with which a pipetting process can be controlled electrically, a piston element 12 on a piston rod 12a, by the movement of which in the piston chamber 18 the fluid sample can be pipetted through the suction channel 19, which ends in an opening in the basal side of the nose cone 11a, a motor device 14 that can be addressed electrically by the control device 15, with which the movement of the piston element can be driven via the transmission 17.

A measurement device comprising a rotational speed sensor 16a is, in the present case, a component of the electronic control device of the motor device 14, here a DC motor 14, and can be considered as a component of the electrical control device 15, with which the measurement device 16a is signal-connected. The measurement device 16a includes a current sensor.

The motor rotates stepwise in the smallest increments a rotor device (not shown), which in turn moves stepwise a spindle of the transmission 17, the rotation of which causes the stepwise translational movement of the piston 12a along the direction A (FIG. 1c), which in this way effectuates the uptake and dispensing of the sample in the transport container resp. out of it.

The pipetting apparatus 1b in FIG. 2b is built similarly to the pipetting apparatus 1a in FIG. 2a, as can be recognized by the same reference numerals. The measurement device 16b integrated into the pipetting apparatus comprises a pressure sensor that measures the pressure in the piston chamber as a measurement value. A closure element 20 is arranged at the lower end of the nose cone 11a. Here, the closure element 20 is a plug which can be plugged onto the nose cone for completely closing the suction channel 19 in the closed position. The closure element 20 serves as a resistance device in a functional checking in order to oppose to the fluid flow, in this case the air flow of the air cushion pipette 1b. The suction channel is completely blocked. A closure element 20 can also be used when executing a functional checking on the pipetting apparatus 1, 1′ and 1a.

The pipetting apparatus 1, 1′, 1a, 1b serves for pipetting fluid samples in a laboratory. It comprises a suction mechanism that comprises an electrically powered motor (14), a piston chamber (18) and a piston element (12) arranged movably therein, driven by the motor, and by the movement of which the suction of a fluid is effectuated by the formation a fluid flow through an open suction channel (19) of the piston chamber. The pipetting apparatus also comprises the data processing control device 15 that comprises at least one data storage device 15a. It contains a measurement device 16a for detecting the motor current drawn by the motor 14, or a pressure sensor 16b for detecting the chamber pressure, as a measurement value for characterizing the physical work performed by the electrically powered movement of this piston element 12 by means of the suction mechanism.

The control device 15 is configured to detect a performance state of the pipetting apparatus 1, 1′, 1a, 1 b, in particular:

a) to acquire at least one value of this measurement value as a function of a defined movement of the piston element 12 (step 201 in FIG. 4)

b) to compare the at least one value of the measurement value with at least one reference value. (Step 202 in FIG. 4)

c) to store the at least one value of this measurement value in the data storage device 15a. (Step 203 in FIG. 4)

In this, step c) (203) can—alternatively or additionally—also be carried out before step b) (202).

The at least one reference value is stored in the data storage device 15a and therefore available. The reference value is determined by the manufacturer in the manufacturing process of pipetting apparatus and stored. In addition, the reference value can be updated by the service if components (e.g. motor, spindle) are exchanged in the event of a maintenance of the pipetting apparatus. The defined movement mentioned in step a) is here a suction movement of the piston element 12 (upward movement of the piston element 12) for aspirating the sample or an ejection movement for dispensing the sample. This movement is defined by a target volume that corresponds to a certain ideal end position of the piston element 12. The piston element 12 is therefore moved, starting from the initial situation, in which the atmospheric pressure is applied in the piston chamber, to the volume-determining end position in which a partial vacuum is applied in the piston chamber. Furthermore, the movement is defined by the pipetting rate. The at least one reference value contains at least one current value, in particular a series of current values, that were determined experimentally beforehand, e.g. by the manufacturer, with this pipette or at least one pipette of the same type, namely with exactly the movement used in step a) with the said target volume and the determined pipetting rate. The current values of the reference development Iref(t) were determined during the movement and are essentially proportional to the pressure in the sample chamber under normal conditions.

FIG. 3a depicts different piston positions of the pipetting apparatuses from FIGS. 2a and 2b while expanding the air in the piston chamber 18 by moving the piston 12 at a fixed speed upwards to a predetermined end position. The suction channel is closed with the closure element. A development of the reference measured values Iₘₒₜ(t) with respect to the piston positions in FIG. 3a is illustrated FIG. 3b; in the diagram, Iₘₒₜ(t) is symbolized by “+”. The central curve in the diagram can correspond to an ideal development according to the reference values, the upper and lower curve define a tolerance range which marks a fault-free state range of the pipette. The functional checking is carried out analogously and results in measured values, that are marked by “x” and “o” in the diagram. In particular, the comparison of a single measured value with a reference measurement value would be sufficient for executing the method, in particular the value acquired when reaching the target volume on the far right. The measurement series “x” illustrates an error condition, as the measured motor current is outside the tolerance range at this piston position, resp. at the moment of reaching the end position of the piston. By means of the functional checking method depicted in FIG. 3a, 3b, a leakage of the suction mechanism can be determined. Also, a contamination or wear of the suction mechanism can be detected, which can manifest itself in particular in an increased value of the measured motor current.

Similarly to FIG. 3a, FIG. 5a depicts different piston positions of the pipetting apparatuses from FIGS. 2a and 2b while expanding the air in the piston chamber 18 by moving the piston 12 at a fixed speed upwards to a predetermined end position. Again, the suction channel is closed with the closure element. A development of the reference measured values Iₘₒₜ(t) with respect to the piston positions in FIG. 5a is illustrated FIG. 5b; in the diagram, Iₘₒₜ(t) is symbolized by “+”. The central curve in the diagram can correspond to an ideal development according to the reference values, the upper and lower curve define a tolerance range which marks a fault-free state range of the pipette. The functional checking is carried out analogously and results in measured values, that are marked by “x” and “o” in the diagram. Unlike the method in FIG. 3a, 3b, in FIG. 5a, 5b the piston remains—in an additional step of the method—for a defined period in its the position that is extended the farthest from the piston chamber, in particular when the maximum motor current is reached, and the motor is powered off. After a delay of e.g. 50 ms to 5 s, the motor is restarted and the measurement value “motor current” is acquired again. If the suction mechanism was working properly, in particular the piston chamber was sealed, the motor would power off immediately because of the maximum motor current being reached—the last value of the measurement value would correspond to the penultimate value of the measurement value within the tolerance, which would manifest itself as the plateau range of the measurement curve. In the case of a leaky piston chamber depicted here, however, the measured motor current is outside the tolerance range, which represents a poor performance state of the pipetting apparatus. The corresponding information is output to the user, in particular via a display of the pipetting apparatus, and/or the measurement value is stored, for the purpose of documentation and/or subsequent evaluation. The measurement series “x” illustrates an error condition also here, as the measured motor current is outside the tolerance range at the moment the piston reaches the end position and after the waiting period. As a result, in particular a leak in the suction mechanism is detected.

FIG. 4a schematically depicts the workflow of the method 200 according to the present invention according to an embodiment on a pipetting apparatus, in which the measurement value consulted for the detection of at least one performance state of the pipetting suction mechanism of a pipetting apparatus (1; 1′; 1a) is the motor current. The steps a) and b) are carried out a total of four times in order to acquire (201) and store (202) four measured values (1+n=3 repetitions) of the measurement value. Finally, a comparison is used to check whether the measured values are within a tolerance range (203). The method is executed preferably when the suction channel 19 is sealed with a sealing plug. In this way, a load state of the pipetting apparatus can be induced efficiently, which is particularly suitable for a functional checking.

FIG. 4b schematically depicts the workflow of the method 200′ according to the present invention according to an embodiment on a pipetting apparatus, in which the measurement value consulted for the detection of at least one performance state of the pipetting suction mechanism of the pipetting apparatus (1, 1′, 1a, 1b) is the pressure in the piston chamber. Other than that, the workflow of the method is analogous to the method 200 in from FIG. 4a.

1. Method (200) for detecting at least one performance state of the pipetting suction mechanism of a pipetting apparatus (1, 1′, 1a, 1b), in particular a pipette or a repeater pipette, wherein the suction mechanism comprises an electrically powered motor (14), a piston chamber (18), and a piston element (12) arranged movably therein and driven by the motor, and by the movement of which the suction of a fluid can be effectuated by the formation of a fluid flow through an open suction channel (19) of the piston chamber, with the pipetting apparatus being configured to acquire the motor current drawn by the motor as measurement value for the characterization of the physical work that is performed by the suction mechanism for the electrically powered movement of said piston element, and
with the method comprising the following steps, which can be carried out by a data-processing control device (15) of the pipetting apparatus:
a) acquiring at least one value of this measurement value in dependence on a defined movement of the piston element; (201)
b) comparing the at least one measurement value with at least one reference value. (202)

2. Method (200′) for detecting at least one performance state of a pipetting suction mechanism of a pipetting apparatus (1, 1′, 1a, 1b), in particular a pipette or a repeater pipette, wherein the suction mechanism comprises an electrically powered motor (14), a piston chamber (18), and a piston element (12) arranged movably therein and driven by the motor, and by the movement of which the suction of a fluid can be effectuated by the formation of a fluid flow through an open suction channel (19) of the piston chamber,
with the pipetting apparatus comprising a resistance device (20), by means of which the mechanical, in particular the hydraulic resistance of the suction mechanism against the physical work performed by the motor is increased during the execution of the method, and
with the pipetting apparatus comprising a pressure sensor (16b) that measures the pressure in the piston chamber, and being configured to acquire the pressure measured by the pressure sensor for the characterization of the physical work that is performed by the suction mechanism for the electrically powered movement of that piston element, and
with the method comprising the following steps that can be executed by a data-processing control device of the pipetting apparatus:
a) acquiring at least one value of this measurement value in dependence on a defined movement of the piston element; (201′)
b) comparing the at least on measurement value with at least one reference value. (202′)

3. Method according to claim 1 or 2, wherein step a) is executed at a moment before a pipetting process that is started by the user and executed with the pipetting apparatus, in particular executed immediately before the start of said pipetting process.

4. Method according to claim 1 or 2, wherein step a) is executed during a movement of the piston element that serves exclusively for the detection of at least one performance state.

5. Method according to claim 4, wherein step a) is executed automatically, and controlled by the control device of the pipetting apparatus, by the execution of a functional checking program.

6. Method according to claim 1, wherein the pipetting apparatus is equipped with a resistance device (20), by means of which the mechanical, in particular the hydraulic resistance of the suction mechanism against the physical work performed by the motor is increased during the execution of the method.

7. Method according to claim 2 or 6, wherein the resistance device is a closure element (20), with which the suction channel (19) is blocked partially or closed completely.

8. Method according to claim 7, wherein the closure element is a closure cap (20).

9. Method according to one of the preceding claims, wherein a number N of values of the measurement value is measured during the movement of the piston element in step a) and stored in a step c), with the measurement and the storing taking place in particular in alternation.

10. Method according to one of the preceding claims, wherein the motor is a DC motor (14) that makes available the information on the drawn motor current via an electrical contact.

11. Method according to one of the claims 1 through 10, comprising the step:
c) storing this at least one value of this measurement value in a data storage device (15a) of the pipetting apparatus. (203)

12. Pipetting apparatus (1; 1′; 1a), in particular a pipette or a repeater pipette for pipetting fluid samples in a laboratory, comprising
a suction mechanism that comprises an electrically powered motor (14), a piston chamber (18), and a piston element (12) arranged movably therein and driven by the motor, and by the movement of which the suction of a fluid can be effectuated by the formation of a fluid flow through an open suction channel (19) of the piston chamber,
a data-processing control device (15) that comprises at least one data storage device (15a),
a measurement device (16a) for the acquisition of the motor current drawn by the motor as a measurement value for the characterization of the physical work that is performed by the suction mechanism for the electrically powered movement of that piston element, and
wherein the control device is configured to detect a performance state of the pipetting apparatus,
a) to acquire at least one value of this measurement value in function of a defined movement of the piston element,
b) to compare the at least one value of the measurement value with at least one reference value.
c) optionally: to store the at least one value of this measurement value in the data storage device.

13. Pipetting apparatus according to claim 12 that is equipped with a resistance device (20), by means of which the mechanical, in particular the hydraulic resistance of the suction mechanism against the physical work performed by the motor is increased during the execution of the method.

14. System of a pipetting apparatus according to claim 12 and a resistance device, by means of which the mechanical, in particular the hydraulic resistance of the suction mechanism against the physical work performed by the motor can be increased during the execution of the method.

15. Pipetting apparatus (1; 1′; 1b), in particular a pipette or a repeater pipette for pipetting fluid samples in a laboratory, comprising
a suction mechanism that comprises an electrically powered motor (14), a piston chamber (18), and a piston element (12) arranged movably therein and driven by the motor, and by the movement of which the suction of a fluid can be effectuated by the formation of a fluid flow through an open suction channel (19) of the piston chamber,
a data-processing control device (15) that comprises at least one data storage device (15a),
a measurement device comprising a pressure sensor (16b) for the acquisition of the pressure applied in the piston chamber as a measurement value for characterizing the physical work that is performed by the suction mechanism for the electrically powered movement of this piston element,
wherein the pipetting apparatus is equipped with a resistance device (20), by means of which during the execution of the method the mechanical, in particular the hydraulic resistance of the suction mechanism against to the physical work performed by the motor is increased,
wherein the control device is configured to detect a performance state of the pipetting apparatus,
a) to acquire at least one value of this measurement value in function of a defined movement of the piston element,
b) to compare the at least one value of the measurement value with at least one reference value.
c) optionally: to store the at least one value of this measurement value in the data storage device.

16. Program code for the implementation of the method according to claim 1 or 2 in a pipetting apparatus that can be executed by a data-processing control device of the pipetting apparatus such that this pipetting apparatus is a pipetting apparatus with the features according to one of the claims 12 through 15 or such that the method according to claim 1 or 2 can be executed by it.
